(19) United States
(12) Patent Application Publication
(10) Pub. No.: US 2019/0036285 A1
(43) Pub. Date: Jan. 31, 2019

(54) HIGH-SPEED TRANSMISSION CONNECTOR AND APPLICATION DEVICE THEREOF

(71) Applicant: Innodisk Corporation, New Taipei City (TW)

(72) Inventors: Chin-Chung KUO, New Taipei City (TW); Shuang-Te CHANG, New Taipei City (TW); Chih-Chieh KAO, New Taipei City (TW); Che-Ming HSU, New Taipei City (TW)

(21) Appl. No.: 15/680,719

(22) Filed: Aug. 18, 2017

(30) Foreign Application Priority Data
Jul. 27, 2017 (TW) 106211042

(51) Int. Cl. H01R 31/06; H01R 13/627; H01R 12/71; H01R 13/621; H01R 13/629

(52) U.S. Cl. CPC H01R 31/06; H01R 13/6273; H01R 2201/06; H01R 13/621; H01R 13/62922; H01R 12/716

(57) ABSTRACT

The present invention provides a high-speed transmission connector and application device thereof. The application device comprises an outer shell that is provided at a bottom end thereof with an OcuLink device connector conforming to an OcuLink transmission specification, and provided at an inside thereof with an application module connected to the OcuLink device connector. The OcuLink device connector can be inserted into an OcuLink board connector disposed on a motherboard, a computer system, or a circuit board. The application device further comprises an engagement element capable of engaging with a fixed element of the OcuLink board connector. The application device is directly electrically connected to the motherboard without the use of the transmission line, it will not only improve the heat dissipation of the motherboar, but also increase the stability of the OcuLink device connector in the insertion.

This non-provisional application claims priority claim under 35 U.S.C. § 119(a) on Taiwan Patent Application No. 106211042 filed Jul. 27, 2017, the entire contents of which are incorporated herein by reference.

### FIELD OF THE INVENTION

The present invention provides a high-speed transmission connector and application device thereof, more particularly, to a connector with a OcuLink transmission interface or a Slimline SAS transmission interface and an application device thereof.

### BACKGROUND

Manufacturer has developed OcuLink transmission interface and SlimLine SAS transmission interface in order to reduce that the use space of motherboard or circuit board is occupied by high-speed storage device or display card, and support the requirement of high-speed transmission. The current OcuLink transmission interface or SlimLine SAS transmission interface is made as cable structure, which is connected to the motherboard or the application device by a transmission line.

FIG. 1 is a schematic view of using an OcuLink transmission interface according to the prior art. As shown in FIG. 1, a board connector 11 with an OcuLink transmission interface is disposed on a computer system, a circuit board, or a motherboard 10. A transmission line 15 is provided at an end thereof with a device connector 151, and provided at other end thereof with a transmission line connector 157. The transmission line 15 is connected to the board connector 11 by the device connector 151, and connected to an application module 17 by the transmission line connector 157. Therefore, the application module 17 and the board connector 11 are connected together by the transmission line 15 conforming to the OcuLink transmission specification. The application module 17 is a memory, a data storage device, a control device, a display card, a network device, or a communication device.

The OcuLink transmission line 15 in tradition a cable structure. Although the OcuLink transmission line 15 that is formed as the cable structure is convenient to arrange the position of the application module 17, it must be placed in a small chassis space of the computer system, in which is not only to unfavorable the heat removal of the computer system, but is easy to generate a colliding and pulling between the OcuLink transmission line 15 and other elements, resulting in the falling of the OcuLink transmission line 15 or the generation of short of circuit.

Therefore, how to provide an application device with an OcuLink connector so as to improve the defect of the OcuLink transmission line in tradition, which is the main object of the present invention to be achieved.

### SUMMARY

It is one object of the present invention to provide an application device with a high-speed transmission connector, more particularly, to an application device with an OcuLink transmission interface or a SlimLine transmission interface. The application device can be directly inserted into a motherboard or a circuit board without the use of the transmission line, in such a way that a space within a computer system will avoid to be occupied by the transmission line so as to improve the heat dissipation of the computer system.

It is another object of the present invention to provide an application device with a high-speed transmission connector, more particularly, to an application device with an OcuLink transmission interface or a SlimLine transmission interface. The application device is able to insert to an OcuLink board connector by an OcuLink device connector. Besides, the OcuLink board connector is provided with a fixed element. By the disposition of the fixed element, it will not only improve the stability of the connection between the OcuLink device connector and the OcuLink board connector, but also increase the security of the data transmission of the OcuLink application devive.

The present invention further provides an application device with a high speed transmission connector, comprising an outer shell, wherein the outlet shell is provided at a bottom end thereof with a high speed transmission device connector, and provided at an inside thereof with an application module, the application module is electrically connected to the high speed transmission device connector, the high speed transmission device connector is an OcuLink device connector or a Slimline device connector.

In one embodiment of the present invention, wherein the outer shell is provided at a side thereof with at least one engagement element, the engagement element is an engagement hook, an engagement slot, an engagement column, an engagement hole, or a surface of the outer shell.

In one embodiment of the present invention, wherein the application module is a memory, a data storage device, a control device, a display card, a network device, or a communication device.

In one embodiment of the present invention, wherein the high speed transmission device connector is able to be inserted into a high speed transmission board connector, the high speed transmission board connector is disposed on a motherboard, a circuit board, or a computer system, the high speed transmission board connector is an OcuLink board connector or a Slimline board connector.

In one embodiment of the present invention, wherein the high speed transmission board connector is provided with a fixed element, when the high speed transmission device connector is inserted into the high speed transmission board connector, an engagement element of the application device engages with the fixed element of the high speed transmission board connector, the application module is electrically connected to the motherboard, the circuit board, or the computer system, the fixed element is a fixed hook, a fixed slot, a fixed hole stand, or a fixed screw.

In one embodiment of the present invention, wherein the engagement element disposed on the outer shell of the application device is an engagement hole, a fixed screw passes the engagement hole to fix the application device on a fixed hole of a motherboard when the application device is inserted into the high speed transmission board connector in a horizontal direction.

The present invention further provides a high speed transmission connector, which is an OcuLink board connector conforming to an OcuLink transmission specification, wherein the OcuLink board connector comprises a seat body, the seat body is provided at a top end thereof with a board slot, and provided at at least one side thereof with a support stand, the support stand is provided with a fixed element, the fixed element is a fixed hook, a fixed slot, a fixed hole stand, or a fixed screw.

In one embodiment of the present invention, wherein an OcuLink device connector is able to be inserted into the OcuLink board connector, the OcuLink device connector is provided with an engagement element capable of engaging with the fixed element of the OcuLink board connector, the OcuLink device connector is provided with an OcuLink data transmission line or an OcuLink application device thereon.

The present invention further provides a high speed transmission connector, which is a Slimline board connector conforming to a Slimline SAS transmission specification, wherein the Slimline board connector comprises a seat body, the seat body is provided at a top end thereof with a board slot, and provided at at least one side thereof with a support stand, the support stand is provided with a fixed element, the fixed element is a fixed hook, a fixed slot, a fixed hole stand, or a fixed screw.

### BRIEF DESCRIPTION OF THE DRAWINGS

FIG. 1 is a schematic view of using an OcuLink transmission interface according to the prior art.

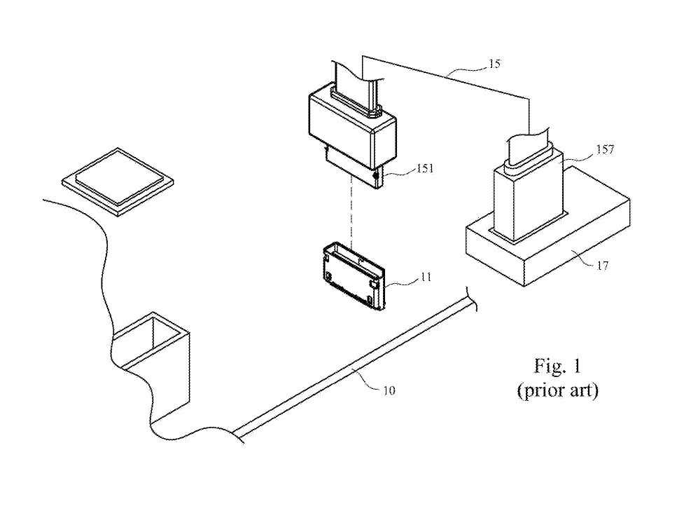

FIG. 2 is a stereogram of an OcuLink application device according to one preferred embodiment of the present invention.

FIG. 3 is a stereogram of an application device according to another embodiment of the present invention.

FIG. 4 is a sectional view of an application device being inserted into an OcuLink board connector according to another embodiment of the present invention.

FIG. 5 is a sectional view of an application device being inserted into an OcuLink board connector according to another embodiment of the present invention.

FIG. 6 is a stereogram of an application device with a high speed transmission connector according to another embodiment of the present invention.

FIG. 7 is a stereogram of an application device with a high speed transmission connector according to another embodiment of the present invention.

FIG. 8 is a stereogram of an application device with a high speed transmission connector according to another embodiment of the present invention.

### DETAILED DESCRIPTION OF THE PREFERRED EMBODIMENTS

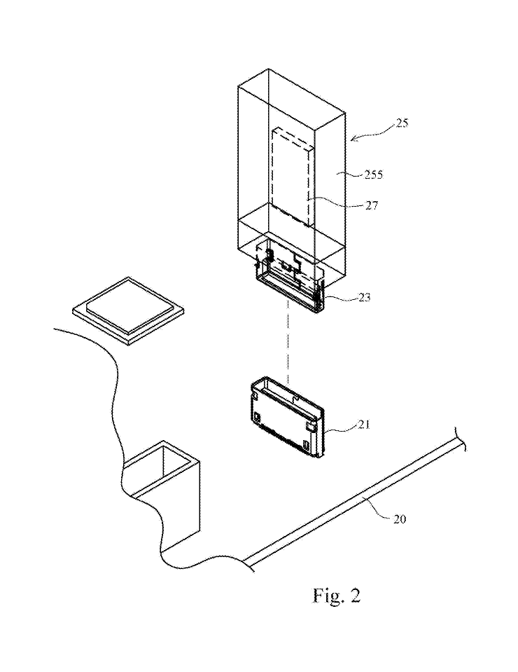

Referring to FIG. 2, there is shown a stereogram of an OcuLink application device according to one preferred embodiment of the present invention. The application device of the present invention is an application device with a high speed transmission device connector. As shown in FIG. 2, the application device 25 comprises an outer shell 255. The outer shell 255 is provided at a front end thereof with an OcuLink device connector 23 conforming to an OcuLink transmission specification. An application module 27 is disposed in the inside of the application device 25, and is electrically connected to the OcuLink device connector 23. The application module 27 may be, for example, but is not limited to, a memory, a data storage device, a control device, an electronic application device, a display card, a communication device, or a network device.

An OcuLink board connector 21 corresponding to the OcuLink device connector 23 is disposed on a computer system, a circuit board, or a motherboard 20. In one embodiment of the present invention, the OcuLink board connector 21 may be an OcuLink board connection seat, the OcuLink device connector 23 may be an OcuLink device connection plug; in other embodiment of the present invention, otherwise, the OcuLink board connector 21 may be an OcuLink board connection plug, the OcuLink device connector 23 may be an OcuLink device connection seat. When the OcuLink device connector 23 is inserted into the OcuLink board connect connector 21, the application module 27 of the application device 25 will be electrically connected to the motherboard 20 so as to become an application element of the computer system, and be executed by the computer system. Accordingly, since the OcuLink application device 25 of the present invention is directly inserted into the OcuLink board connector 21 without the use of the transmission line, the defect that the heat dissipation of the computer system is poor because of the transmission line will be avoided, or the problem that the transmission line falls because of improperly pulling between components will be not happened.

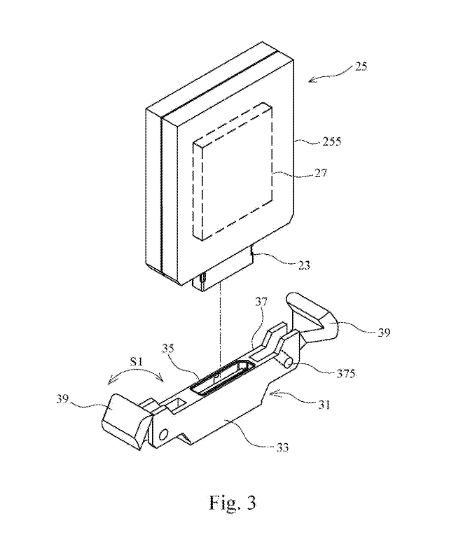

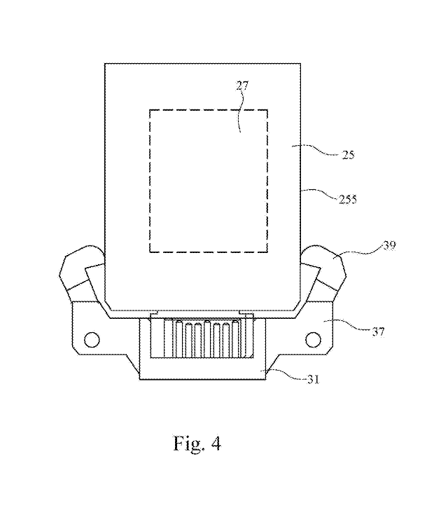

Referring to FIG. 3 and FIG. 4, there are shown a stereogram of an application device according to another embodiment of the present invention and a sectional view of an application device being inserted into an OcuLink board connector according to another embodiment of the present invention. As shown in FIG. 3 and FIG. 4, the application device 25 is able to be inserted into an OcuLink board connector 31 by the OcuLink device connector 23. The OcuLink board connector 31 comprises a seat body 33 that is provided with a board slot 35. The board slot 35 is provided at at least one side thereof with a support stand 37. One or more fixed element 39, for example, engagement hook, are disposed on the support stand 37 by a corresponding positioning shaft 375. Thus, the fixed element 39 can swing up and down or front and rear, or move a distance Si by the positioning of the positioning shaft 375.

The OcuLink board connector 31 is fixed on a circuit board 20. When the application device 25 desires to be inserted into the OcuLink board connector 31, the fixed elements 39 can be moved outward. When the application device 25 has inserted into the OcuLink board connector 31, the fixed elements 39 will be moved inward so as to abut against an engagement element, for example, the surface of the outer shell 255, of the application device 25. The application device 25 can be installed in the OcuLink board connector 31 steadly because the fixed elements 39 abuts against the surface of the outer shell 255, in such a way that the application device 25 is not easy departed from the OcuLink board connector 31 when the colliding of an external force is generated on the application device 25 or the computer system is moved. Therefore, the security of the data transmission between the application device 25 and the computer system can be increased.

In the present embodiment, the fixed element 39 is fixed on the support stand 37 by the positioning shaft 375. In other embodiment, otherwise, the fixed elements 39 may be fixed on the OcuLink board connector 31 by a tight fit, a rivet, or a fixed bump.

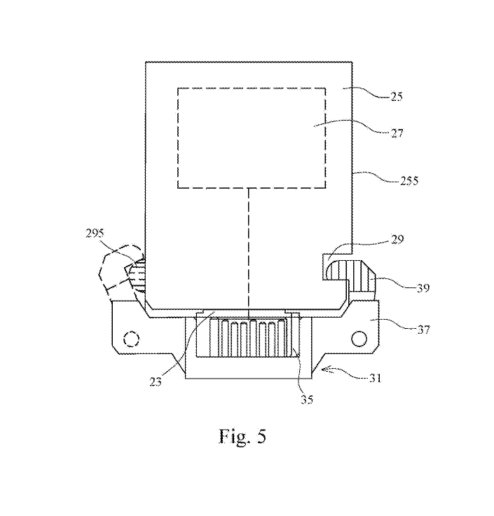

Referring to FIG. 5, there is a sectional view of an application device being inserted into an OcuLink board connector according to another embodiment of the present invention. As shown in FIG. 5, the application device 25 is provided at a bottom end thereof with an OcuLink device connector 23. The OcuLink device connector 23 is inserted into the board slot 35 of the OcuLink board connector 31 so that the application device 25 is able to be electrically connected to the motherboard. Corresponding to the disposed position and the number of the fixed elements 39, the outer shell 255 of the application device 25 is provided at the side thereof with at least one engagement element, for example, engagement slot 29 or engagement column 295. The application device 25 is provided at the inside thereof with at least one application module 27, for example, memory element, programming element, or microprocessor.

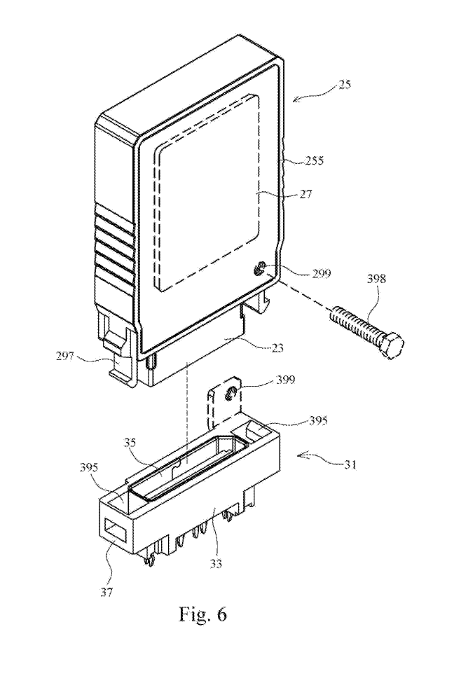

Referring to FIG. 6, there is a stereogram of an application device according to another embodiment of the present invention. As shown in FIG. 6, the outer shell 255 of the application device 25 is provided at the bottom end thereof with at least one engagement element, which may be an engagement hook 297 except the engagement slot (29) or the engagement column (295) disclosed in FIG. 5. Based on the engagement hook 297 of the application device 25, the OcuLink board connector 31 is provided with a corresponding fixed element, for example, the support stand 37 of the OcuLink board connector 31 is provided with a fixed slot 395 thereon. When the OcuLink device connector 23 of the application device 25 is inserted into the board slot 35 of the OcuLink board connector 31, the engagement hook 297 of the application device 25 will be embedded and fixed in the fixed slot 395 of the OcuLink board connector 31 so as to enhance the stability of insertion of the application device 25.

In another present embodiment, the engagement element of the application device 25 is an engagement hole 299, for example, but not limited to, a screw hole, a stud hole, or pass hole. The engagement element of the OcuLink board connector 31 corresponding to the engagement hole 299 of the application device 25 comprises a fixed hole stand 399 and a fixed screw 398. When the OcuLink device connector 23 of the application device 25 is inserted into the board slot 35 of the OcuLink board connector 31, the engagement hole 299 of the application device 25 and the fixed hole stand 399 of the OcuLink board connector 31 can be locked together by the fixed screw 398 of the OcuLink board connector 31, so as to enhance the stability of insertion of the application device 25.

In another present embodiment, the fixed hole stand 399 of the OcuLink board connector 31 may be a fixed hole disposed on the motherboard (20). And, the opening direction of the board slot 35 of the OcuLink board connector 31 is parallel to the surface of the circuit board 10. Thus, the fixed screw 398 can pass the engagement hole 299 of the application device 25 to fix the application device 25 on the fixed hole of the motherboard (20) when the application device 25 is inserted into the board slot 35 of the OcuLink board connector 31 in a horizontal direction, so as to enhance the stability of insertion of the application device 25, similarly.

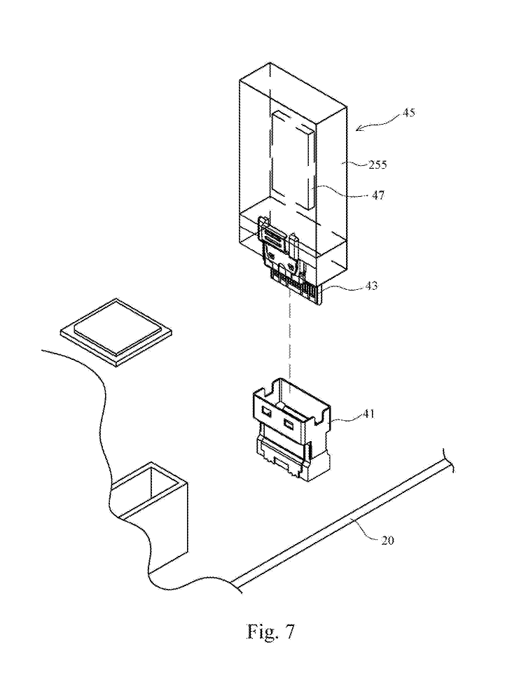

Referring to FIG. 7, there is a stereogram of an application device with high speed transmission connector according to another embodiment of the present invention. In the above described embodiment, the device connector 23 and the board connector 31 are the high-speed transmission connectors conforming to the OcuLink transmission specification, and the application device 25 is an OcuLink application device 25 with the OcuLink device connector 23. In the present embodiment, the device connector 43 and the board connector 41 are the high-speed transmission connectors conforming to the Slimline SAS transmission specification, and the application device 45 is a Slimline application device with the Slimline device connector 43.

The application device 45 comprises an outer shell 255, which is provided at a front end thereof with the Slimline device connector 43 conforming to the Slimline SAS transmission specification. An application module 27 is disposed in the outer shell 255, and electrically connected to the Slimline device connector 43. The application module 27 may be, for example, but is not limited to, a memory, a data storage device, a control device, an electronic application device, a display card, a communication device, and/or a network device.

A Slimline board connector 41 corresponding to the Slimline device connector 43 is disposed on a computer system, a circuit board, or a motherboard 20. When the Slimline device connector 43 is inserted into the Slimline board connect connector 41, the application module 47 of the application device 45 will be electrically connected to the motherboard 20 so as to become an application element of the computer system, and be executed by the computer system. Accordingly, since the Slimline application device 45 of the present invention is directly inserted into the Slimline board connector 41 without the use of the transmission line, the defect that the heat dissipation of the computer system is poor because of the transmission line will be avoided, or the problem that the transmission line falls because of improperly pulling between components will be not happened.

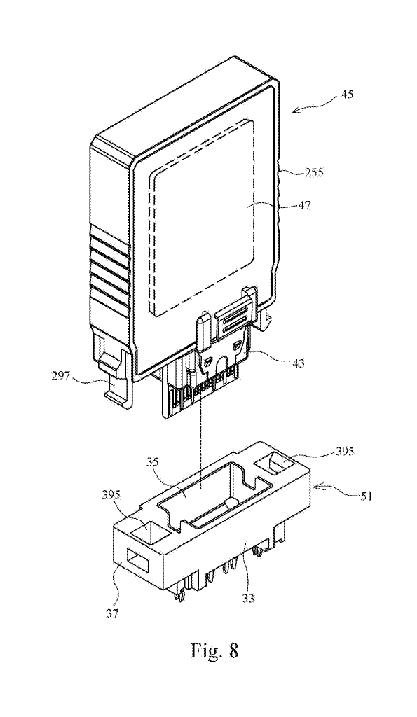

Referring to FIG. 8, there is a stereogram of an application device with high speed transmission connector according to another embodiment of the present invention. As shown in FIG. 8, the outer shell 255 of the application device 45 is provided at the side thereof with at least one engagement element, which may be an engagement hook 297. The Slimline board connector 51 comprises a seat body 33 and a board slot 35 conforming to the Slimline SAS transmission specification. The seat body 33 is provided at a side thereof with the support stand 37. Based on the engagement hook 297 of the application device 45, the support stand 37 is provided with at least one fixed element, for example, the fixed slot 395. When the Slimline device connector 43 of the application device 45 is inserted into the board slot 35 of the Slimline board connector 51, the engagement hook 297 of the application device 45 will be embedded and fixed in the fixed slot 395 of the Slimline board connector 51 so as to enhance the stability of insertion of the application device 45.

The engagement element of the application device 45 may be an engagement hole, an engagement column, an engagement slot or the surface of the outer shell, except of the engagement hook 297. The fixed element of the Slimline board connector 51 may be an engagement hook, a fixed hole stand or a fixed screw, except of the fixed slot 395.

In another embodment of the present invention, if the Slimline board connector 51 is provided with the fixed element 39, the corresponding Slimline device connector 43 will be provided at the side thereof with the engagement element 29 that can engage with the fixed element 39 each other. Thus, the Slimline device connector 43 with high speed transmission may be designed as a high speed transmission line or a high speed transmission application device.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

1. An application device with a high speed transmission connector, comprising an outer shell, wherein the outlet shell is provided at a bottom end thereof with a high speed transmission device connector, and provided at an inside thereof with an application module, the application module is electrically connected to the high speed transmission device connector, the high speed transmission device connector is an OcuLink device connector or a Slimline device connector.

2. The application device according to claim 1, wherein the outer shell is provided at a side thereof with at least one engagement element, the engagement element is an engagement hook, an engagement slot, an engagement column, an engagement hole, or a surface of the outer shell.

3. The application device according to claim 1, wherein the application module is a memory, a data storage device, a control device, a display card, a network device, or a communication device.

4. The application device according to claim 1, wherein the high speed transmission device connector is able to be inserted into a high speed transmission board connector, the high speed transmission board connector is disposed on a motherboard, a circuit board, or a computer system, the high speed transmission board connector is an OcuLink board connector or a Slimline board connector.

5. The application device according to claim 4, wherein the high speed transmission board connector is provided with a fixed element, when the high speed transmission device connector is inserted into the high speed transmission board connector, an engagement element of the application device engages with the fixed element of the high speed transmission board connector, the application module is electrically connected to the motherboard, the circuit board, or the computer system, the fixed element is a fixed hook, a fixed slot, a fixed hole stand, or a fixed screw.

6. The application device according to claim 2, wherein the engagement element disposed on the outer shell of the application device is an engagement hole, a fixed screw passes the engagement hole to fix the application device on a fixed hole of a motherboard when the application device is inserted into the high speed transmission board connector in a horizontal direction.

7. A high speed transmission connector, which is an OcuLink board connector conforming to an OcuLink transmission specification, wherein the OcuLink board connector comprises a seat body, the seat body is provided at a top end thereof with a board slot, and provided at at least one side thereof with a support stand, the support stand is provided with a fixed element, the fixed element is a fixed hook, a fixed slot, a fixed hole stand, or a fixed screw.

8. The high speed transmission connector according to claim 7, wherein an OcuLink device connector is able to be inserted into the OcuLink board connector, the OcuLink device connector is provided with an engagement element capable of engaging with the fixed element of the OcuLink board connector, the OcuLink device connector is provided with an OcuLink data transmission line or an OcuLink application device thereon.

9. A high speed transmission connector, which is a Slimline board connector conforming to a Slimline SAS transmission specification, wherein the Slimline board connector comprises a seat body, the seat body is provided at a top end thereof with a board slot, and provided at at least one side thereof with a support stand, the support stand is provided with a fixed element, the fixed element is a fixed hook, a fixed slot, a fixed hole stand, or a fixed screw.

10. The high speed transmission connector according to claim 9, wherein a Slimline device connector is able to be inserted into the Slimline board connector, the Slimline device connector is provided with an engagement element capable of engaging with the fixed element of the Slimline board connector, the Slimline device connector is provided with a Slimline data transmission line or a Slimline application device thereon.
